(19) United States
(12) Patent Application Publication
(10) Pub. No.: US 2014/0251252 A1
(43) Pub. Date: Sep. 11, 2014

(54) COMPRESSION SELF-IGNITION ENGINE

(71) Applicant: Mazda Motor Corporation, Aki-gun (JP)

(72) Inventors: Mitsunori Wasada, Hiroshima-shi (JP); Naoyuki Yamagata, Higashihiroshima-shi (JP); Tomokuni Kusunoki, Aki-gun (JP); Takuya Hamada, Hiroshima-shi (JP)

(73) Assignee: Mazda Motor Corporation, Aki-gun (JP)

(21) Appl. No.: 14/151,702

(22) Filed: Jan. 9, 2014

(30) Foreign Application Priority Data
Mar. 11, 2013 (JP) 2013-048134

(51) Int. Cl. F02M 31/04; F02M 31/20

(52) U.S. Cl. CPC F02M 31/042; F02M 31/20
USPC 123/184.21

(57) ABSTRACT

A compression self-ignition engine is provided. The engine includes an engine body and an intake passage, and CI combustion is performable in a part of an engine operating range. The intake passage includes a high-temperature passage provided with a heater for heating intake air, a low-temperature passage provided with a cooler for cooling the intake air, a manifold section where the high-temperature and low-temperature passages merge together, and a downstream passage connecting the manifold section with the engine body. A throttle valve for adjusting a flow rate of the intake air is provided in each of the high-temperature and low-temperature passages. At least in an engine operating range where the CI combustion is performed, openings of the throttle valves are controlled to bring a temperature of the intake air within the manifold section into a predetermined temperature range, based on temperature conditions of the heater and the cooler, respectively.

### BACKGROUND

The present invention relates to a compression self-ignition engine which performs CI combustion where fuel containing gasoline is combusted by a self-ignition, at least in a part of an operating range of the engine.

Conventionally, in the field of gasoline engines, spark-ignition combustion in which mixture gas is forcibly combusted by a spark-ignition from an ignition plug has been generally adopted. However, recently, instead of such spark-ignition combustion, application of so-called compression self-ignition combustion to gasoline engines has been studied. Compression self-ignition combustion is combustion in which mixture gas is combusted by substantially-simultaneous self-ignitions under an environment with high temperature and high pressure created by compression of a piston, and it has been known to have a shorter combustion period and a higher thermal efficiency compared to spark-ignition combustion in which combustion gradually spreads by flame-propagation. Note that, hereinafter, spark-ignition combustion is abbreviated to “SI combustion” and compression self-ignition combustion is abbreviated to “CI combustion.”

The CI combustion is hard to occur in a low engine load range where a fuel injection amount is small and, thus a heat release amount is small. Therefore, in order to surely cause the CI combustion even in such a low engine load range, it has been proposed to provide an intake air heating part for forcibly heating intake air introduced into the engine body. For example, JP 1999-062589A and JP2006-283618A disclose compression self-ignition engines including intake air heating parts.

In the engine of JP1999-062589A, a heat exchanger for heating intake air by a heat exchange with exhaust gas is provided in an exhaust passage. A bypass passage branching from an intake passage, through the heat exchanger, and then returning back to the intake passage is provided between the intake passage and the exhaust passage of the engine. A switch valve is provided in a connection section between a downstream end section of the bypass passage and the intake passage, a branched flow of the intake air is controlled by an opening of the switch valve. Specifically, when the engine of JP1999-062589A is in a partial load operation, the switch valve is controlled to allow the branched flow to flow into the bypass passage. Thus, the intake air is introduced into the heat exchanger through the bypass passage, the intake air heated by the heat exchanger is introduced into the engine body, and thus, the CI combustion is promoted. On the other hand, if the engine load increases in this state, occurrence of knocking will be concerned. Therefore, when it is determined that knocking has occurred, the switch valve is controlled to block the branched flow into the bypass passage, and the heating of the intake air is stopped. Further, in a full engine load range, the heating of the intake air is stopped and the combustion mode is switched from the CI combustion into the SI combustion.

In the engine of JP2006-283618A, a heater serving as the intake air heating part is provided in a bypass passage for bypassing an intake passage. A three-way electromagnetic valve is provided in a downstream end section of the bypass passage (a connection section with the intake passage). By a switch control of the three-way electromagnetic valve, a state of the intake air flow is switched from a state where high-temperature intake air heated through the heater is introduced into the engine body, into a state where non-heated intake air which does not pass through the heater is introduced into the engine body (or the other way around).

According to JP1999-062589A and JP2006-283618A, the intake air introduced into the engine body can be switched between the high-temperature intake air heated by the heating part and the non-heated intake air, according to an operating state of the engine. Thus, there is an advantage that the range where suitable CI combustion can be performed can be expanded.

However, the heating temperature by the heating part may not always be kept fixed. Particularly, as JP1999-062589A, when the heat exchanger for heating the intake air by the heat exchange with the exhaust gas of the engine is provided as the heating part, since the temperature of the exhaust gas varies depending on the warming-up stage of the engine and the operating state of the engine, the heating temperature of the intake air also varies accordingly. Moreover, even in the case of supplying the non-heated intake air which does not pass the heating part to the engine body, the temperature of the non-heated intake air varies directly by the temperature of outdoor air.

In both JP1999-062589A and JP2006-283618A, since the heating part is provided in the bypass passage branched from the intake passage, and the switch valve (e.g., the three-way electromagnetic valve) is provided in the downstream end section of the bypass passage (the connection section with the intake passage), the intake air can basically only be switched between being heated and not being heated by the heating part (being branched and not being branched to the bypass passage). Therefore, the temperature of the intake air introduced into the engine body cannot avoid varying by the temperature of a heat source (e.g., exhaust gas) of the heating part and the temperature of outdoor air. This makes it difficult to stably achieve suitable CI combustion, causing misfire and abnormal combustion.

### SUMMARY

The present invention is made in view of the above situations and provides a compression self-ignition engine which controls the temperature of intake air in an execution range of CI combustion with high accuracy.

According to one aspect of the invention, a compression self-ignition engine is provided. The engine includes an engine body driven by fuel containing gasoline, and an intake passage through which intake air introduced into the engine body flows. CI combustion in which the fuel combusts by self-ignition, is performable in at least a part of an engine operating range. The intake passage includes a high-temperature passage provided with a heater for heating intake air, a low-temperature passage provided with a cooler for cooling the intake air, a manifold section where the high-temperature passage and the low-temperature passage merge together, and a downstream passage connecting the manifold section with the engine body. A throttle valve for adjusting a flow rate of the intake air is provided in each of the high-temperature passage and the low-temperature passage. At least in an engine operating range where the CI combustion is performed, openings of the throttle valves for the high-temperature and low-temperature passages are controlled to bring a temperature of the intake air within the manifold section into a predetermined temperature range, based on temperature conditions of the heater and the cooler, respectively.

In this aspect, the heater and the cooler are provided in the separate passages (the high-temperature passage and the low-temperature passage) respectively, and the throttle valves for adjusting the flow rates are provided inside the respective passages. Therefore, even if the temperature conditions of the heater and the cooler vary according to the situation (e.g., the warming-up stage of the engine and the outdoor air temperature), by flexibly adjusting the mixing ratio of the intake air from the high-temperature passage and the low-temperature passage, the temperature of the mixed intake air, in other words, the temperature of the intake air introduced into the engine body after merging together in the manifold section, can be brought into the predetermined temperature range in high accuracy. Moreover, since the flow rates inside the high-temperature passage and the low-temperature passage can be controlled by the respective throttle valves individually, the mixed intake air can be adjusted with excellent responsiveness. Thus, in the operating range where the CI combustion is performed, the environment where the fuel self-ignites at a suitable timing can surely be created and the stability of the CI combustion can be improved.

The engine may also include a heating temperature detector for detecting a temperature of a heating source of the heater, and a cooling temperature detector for detecting a temperature of a cooling source of the cooler. The openings of the throttle valves for the high-temperature and low-temperature passages may be controlled based on detection values from the heating temperature detector and the cooling temperature detector, respectively.

According to this configuration, the flow rates inside the high-temperature passage and the low-temperature passage can be suitably controlled by the respective throttle valves based on the temperature of the heating source which controls the temperature of the intake air after passing through the heater and the temperature of the cooling source which controls the temperature of the intake air after passing through the cooler. Thus, the accuracy of the temperature control described above can be improved.

A difference between distribution resistance of the intake air flowing inside the heater and distribution resistance of the intake air flowing inside the cooler may be within a range of 20% under the same flow rate.

According to this configuration, when the openings of the throttle valves are changed, since a difference in response delay caused between the flow rates inside the high-temperature and low-temperature passages which change according to the change of the openings is not significant, the temperature of the intake air introduced into the engine body can easily and surely be brought into the predetermined temperature range.

The throttle valves for the respective high-temperature and low-temperature passages may both be butterfly throttle valves. A bore diameter of the throttle valve for the high-temperature passage may be set smaller than a bore diameter of the throttle valve for the low-temperature passage.

According to this configuration, an amount of leakage caused when the throttle valve for the high-temperature passage is fully closed can be reduced. Thus, abnormal combustion (e.g., knocking) can effectively be prevented in an engine operating range where the temperature increase of the intake air degrades the combustion stability, for example, near a maximum engine load.

The throttle valve for the high-temperature passage may be provided downstream of the heater within the high-temperature passage.

According to this configuration, compared to the case where the throttle valve for the high-temperature passage is provided upstream of the heater, a volume of a part of the high-temperature passage on the downstream side of the throttle valve, where the high-temperature intake air may exist can be reduced. Therefore, once the throttle valve is fully closed, the high-temperature intake air is used up in the respective cylinders of the engine body within an extremely short period of time. Thus, it can be avoided that the high-temperature intake air is introduced into the engine body at an unsuitable timing; therefore, abnormal combustion which may occur in a transitive situation can effectively be prevented.

### BRIEF DESCRIPTION OF THE DRAWINGS

FIG. 1 is a view illustrating an overall configuration of a compression self-ignition engine according to one embodiment of the present invention.

FIG. 2 is a view schematically illustrating a configuration of a high temperature passage and a low temperature passage provided to the engine.

FIG. 3 is a block diagram illustrating a control system of the engine.

FIG. 4 is a map of an operating range of the engine divided into a plurality of ranges according to differences in combustion mode.

FIG. 5 is a flowchart illustrating a procedure of a control performed while the engine is in operation.

FIG. 6 illustrates views showing transitions of various state amounts when an engine load is changed.

### DETAILED DESCRIPTION OF EMBODIMENT

### (1) Overall Configuration of Engine

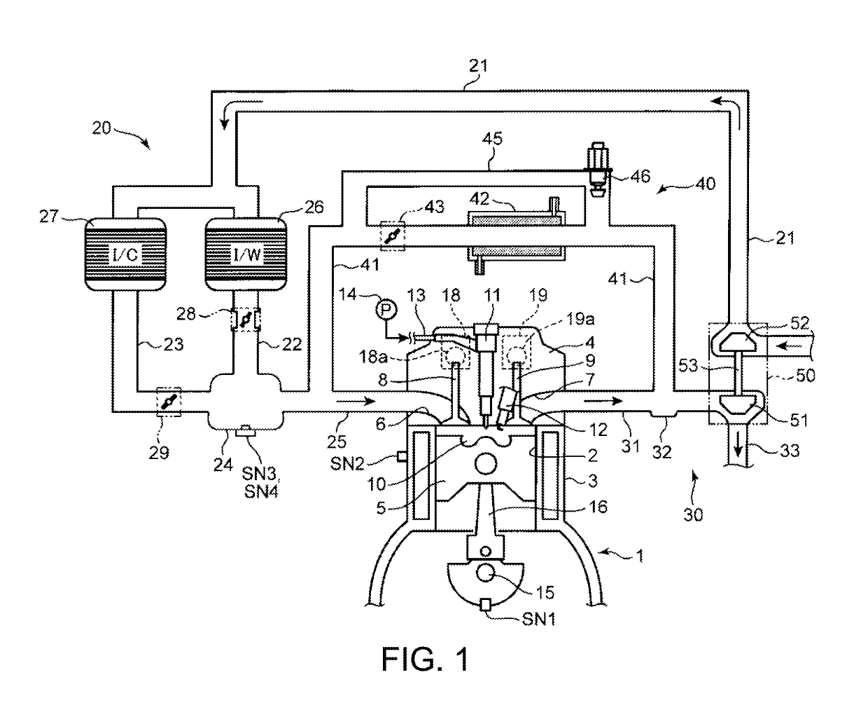

FIG. 1 is a view illustrating an overall configuration of a compression self-ignition engine according to one embodiment of the present invention. The engine in FIG. 1 is a four-cycle gasoline engine to be installed in a vehicle, as a power source for traveling. Specifically, the engine includes an engine body 1 having a plurality of cylinders 2 arranged substantially in line in a direction perpendicular to the drawing sheet of FIG. 1 (only one of the cylinders is illustrated in FIG. 1), an intake passage 20 for introducing air into the engine body 1, an exhaust passage 30 for discharging exhaust gas generated in the engine body 1, an EGR device 40 for circulating a part of the exhaust gas flowing inside the exhaust passage 30 back into the intake passage 20, and a turbocharger 50 driven by energy of the exhaust gas.

The engine body 1 includes a cylinder block 3 formed therein with the plurality of cylinders 2, a cylinder head 4 provided on the cylinder block 3, and pistons 5 reciprocatably fitted into the respective cylinders 2.

A combustion chamber 10 is formed above each piston 5, and the combustion chamber 10 is supplied fuel by the injection from an injector 11 (described later). Then the injected fuel is combusted in the combustion chamber 10, the piston 5 is pushed downward by an expansion force generated by the combustion, and, thus, the piston 5 reciprocates in up-and-down directions. Note that, since the engine of this embodiment is a gasoline engine, gasoline is used as the fuel. However, the fuel is not necessarily entirely gasoline, and may contain a sub-component, such as alcohol.

The piston 5 is coupled to a crankshaft 15 which is an output shaft of the engine body 1, via a connecting rod 16 so that the crankshaft 15 rotates centering on its central axis according to the reciprocation of the piston 5.

A geometric compression ratio of each cylinder 2, in other words, a ratio between a volume of the combustion chamber 10 when the piston 5 is at a bottom dead center (BDC) and a volume of the combustion chamber 10 when the piston 5 is at a top dead center (TDC) is set to between 17:1 and 23:1, which is significantly high for a gasoline engine. This is because the temperature and the pressure of the combustion chamber 10 are required to be increased significantly so as to achieve CI combustion in which the gasoline is combusted by a self-ignition.

The cylinder head 4 is formed with: intake ports 6 for introducing air supplied from the intake passage 20 (hereinafter, may be referred to as intake air) into the combustion chambers 10 of the respective cylinders 2; and exhaust ports 7 for discharging the exhaust gas generated in the combustion chambers 10 of the respective cylinders 2 to the exhaust passage 30. The cylinder head 4 is provided with: intake valves 8 for opening and closing the intake ports 6 on the combustion chamber 10 side and exhaust valves 9 for opening and closing the exhaust ports 7 on the combustion chamber 10 side.

The intake and exhaust valves 8 and 9 are opened and closed by respective valve operating mechanisms 18 and 19 including a pair of camshafts disposed in the cylinder head 4, in cooperation with the rotation of the crankshaft 15.

The valve operating mechanism 18 for the intake valves 8 includes changeable mechanisms 18a for continuously changing lifts of the intake valves 8 (in a non-step fashion). The changeable mechanism 18a with such a configuration is already known as, for example, a continuous variable valve lift (CVVL) mechanism, and specifically, for example, the changeable mechanism 18a includes: a link mechanism for reciprocatably swinging a cam for driving the intake valve 8, in cooperation with the rotation of a camshaft; a control arm for changeably setting the arrangement of the link mechanism (lever ratio); and a stepping motor for changing a swinging amount of the cam (an amount of pushing down the intake valve 8 to open and a period thereof) by electrically driving the control arm.

The valve operating mechanism 19 for the exhaust valves 9 includes switch mechanisms 19a for activating and deactivating a function of pushing down the exhaust valve 9 during the intake stroke. Specifically, each switch mechanism 19a has a function of controlling the exhaust valve 9 to open not only on exhaust stroke but also on the intake stroke, and switching between executing and stopping the opening operation of exhaust valve 9 during the intake stroke (i.e., open-twice control of the exhaust valve 9).

The switch mechanism 19a with such a configuration is already known, and specifically, for example, such a switch mechanism 19a includes: a sub-cam for pushing down the exhaust valve 9 during the intake stroke separately to a normal cam for driving the exhaust valve 9 (the cam for pushing down the exhaust valve 9 during the exhaust stroke), and a so-called lost motion mechanism for activating and deactivating a transmission of the drive force of the sub-cam to the exhaust valve 9.

When the function of pushing down the exhaust valve 9 by the sub-cam of the switch mechanism 19a is activated, the exhaust valve 9 is opened not only on the exhaust stroke but also on the intake stroke. Thus, a so-called internal EGR in which high-temperature exhaust gas flows back into the combustion chamber 10 from the exhaust port 7 is achieved to increase the temperature of the combustion chamber 10 and reduce an amount of the intake air to be introduced into the combustion chamber 10.

In the cylinder head 4, a pair of an injector 11 and an ignition plug 12 is provided for each cylinder 2. The injector 11 injects the fuel (gasoline) to the combustion chamber 10. The ignition plug 12 supplies spark-energy to mixture gas containing the fuel injected from the injector 11 and the air by discharging a spark.

The injector 11 is arranged in the cylinder head 4 to oppose to a top face of the piston 5. The injector 11 of each cylinder 2 is connected with a fuel supply tube 13 so that the fuel (gasoline) supplied thereto through the fuel supply tube 13 is injected from a plurality of nozzle holes (not illustrated) formed in a tip portion of the injector 11.

More specifically, a supply pump 14 comprised of a plunger pump driven by the engine body 1 is provided upstream of the fuel supply tube 13, and a common rail (not illustrated) commonly used for all the cylinders and for accumulating a pressure is provided between the supply pump 14 and the fuel supply tube 13. The fuel applied with the pressure accumulated in the common rail is supplied to the injector 11 of each cylinder 2, and thus, the fuel can be injected from the injector 11 at a high pressure of about 120 MPa at the maximum.

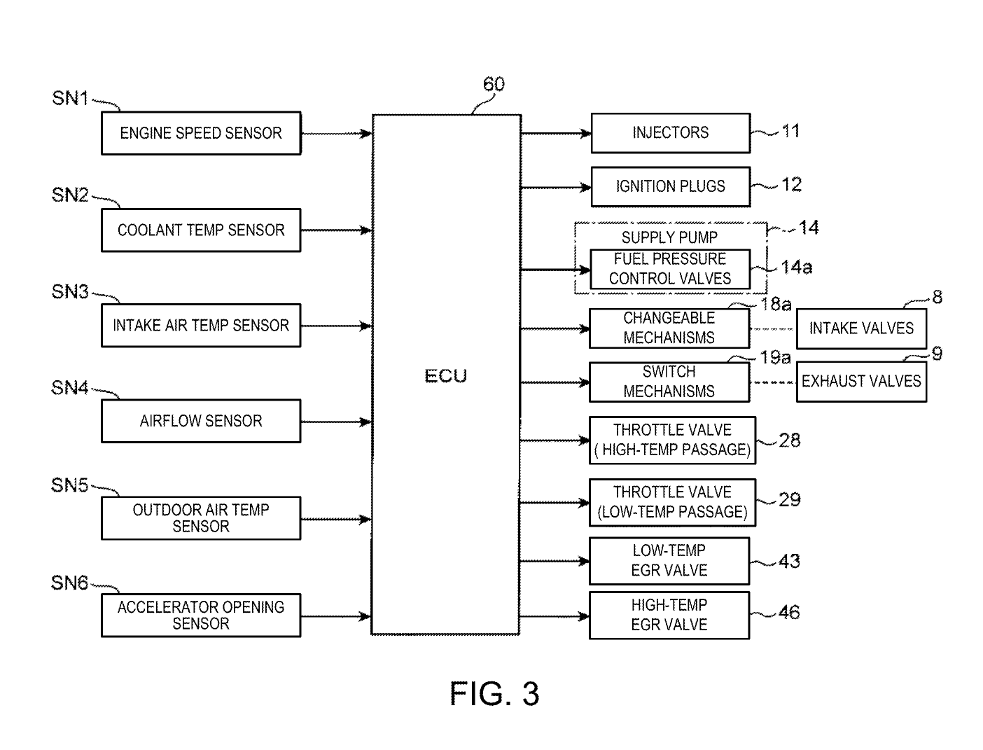

The injection pressure of the fuel (hereinafter, may simply be referred to as the fuel pressure) to be injected from the injector 11 can be adjusted by increasing or reducing an amount of pumping a part of the fuel sent from the supply pump 14 back into a fuel tank side (fuel releasing amount). Specifically, a fuel pressure control valve 14a (see FIG. 3) for adjusting the fuel releasing amount is provided inside the supply pump 14 so that the fuel pressure is adjusted within a predetermined range (e.g., between 20 and 120 MPa) by using the fuel pressure control valve 14a.

The intake passage 20 has a single common passage 21, a high-temperature passage 22 and a low-temperature passages 23 binary branched from a downstream end section (a downstream end section in the flow direction of the intake air) of the common passage 21, a surge tank 24 having a predetermined volume connected with downstream end sections of the passages 22 and 23, and a plurality of independent passages 25 (only one of them is illustrated in FIG. 1) extending downstream from the surge tank 24 and communicating with the intake ports 6 of the respective cylinders 2. Note that, the surge tank 24 corresponds to the “manifold section” in the claims and the independent passages 25 correspond to the “downstream passages” in the claims.

The high-temperature passage 22 is provided therein with an inter warmer 26 for heating the intake air. The inter warmer 26 is a heat exchanger for heating the intake air by the heat exchange with a coolant for cooling the engine body 1. The inter warmer 26 corresponds to the “heater” in the claims. Although the detailed illustration is omitted, multiple tubes where the intake air flows therein are disposed inside the inter warmer 26 and the coolant of the engine is introduced into a peripheral section of the tubes. The intake air flown into the high-temperature passage 22 is divided and flows into the multiple tubes inside the inter warmer 26, and while flowing therein, the intake air is heated by the heat exchange with the coolant of the engine. As a result, the temperature of the intake air after passing through the inter warmer 26 is increased to substantially the same temperature as the temperature of the coolant of the engine (between approximately 75 and 90° C. in a warmed-up state where the warming up of the engine is completed).

The low-temperature passage 23 is provided therein with an inter cooler 27 for cooling the intake air. The inter cooler 27 is an air-cooled type heat exchanger for cooling the intake air by the heat exchange with traveling air introduced into an engine room of the vehicle. The inter cooler 27 corresponds to the “cooler” in the claims. Although the detailed illustration is omitted, multiple tubes where the intake air flows therein are disposed inside the inter cooler 27 and the traveling air is introduced into a peripheral section of the tubes. The intake air flown into the low-temperature passage 23 is divided and flows into the multiple tubes inside the inter cooler 27, and while flowing therein, the intake air is cooled by the heat exchange with the traveling air. Thus, the intake air of which temperature is increased in the process of flowing inside the common passage 21 of the intake passage 20, particularly the intake air of which temperature is increased by being compressed by the turbocharger 50 is again cooled to the temperature substantially the same as that of outdoor air via the inter cooler 27.

The structure, more specifically, an inner diameter and a length of each heat exchanging tube of the inter warmer 26 and the inter cooler 27 are set such that a difference in distribution resistance between the inter warmer 26 and the inter cooler 27 is within a range of 20% under the same flow rate. Here, the distribution resistance is a value indicating a pressure loss with force. Therefore, the difference in distribution resistance within the range of 20% means that the difference in pressure loss is within the range of 20%.

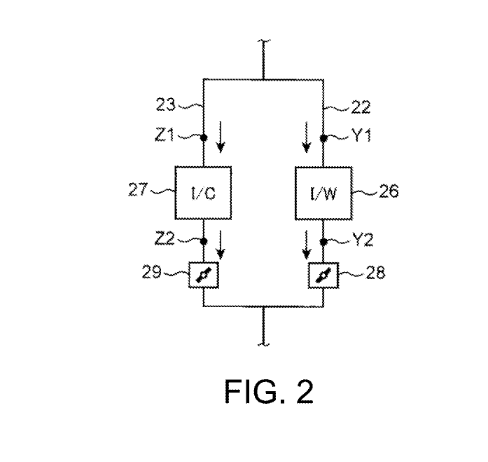

This is described in detail with reference to FIG. 2. With the difference in pressure loss within the range of 20%, under a condition that the intake air flows at the same flow rate in the inter warmer 26 and the inter cooler 27, a relation of |ΔP1−ΔP2/ΔP×100<20 is satisfied, in which ΔP1 indicates the pressure loss obtained by subtracting a pressure at a position Y2 on a downstream side of the inter warmer 26 from a pressure at a position Y1 on an upstream side of the inter warmer 26, and ΔP2 indicates the pressure loss obtained by subtracting a pressure at a position Z2 on a downstream side of the inter cooler 27 from a position Z1 on an upstream side of the inter cooler 27.

In this embodiment, by adjusting the inner diameter and the length of each heat exchanging tube disposed inside the inter warmer 26 and the inter cooler 27, the relation described above is satisfied. Note that, multiple fins are provided inside the tube in some cases so as to increase the heat exchange efficiency, and in this case, the shape and the number of the fins are also considered to satisfy the relation described above.

Returning back to FIG. 1, a throttle valve 28 for adjusting the flow rate of the intake air flowing inside the high-temperature passage 22 is provided inside a part of the high-temperature passage 22 on the downstream side of the inter warmer 26 (between the inter warmer 26 and the surge tank 24). Similarly, a throttle valve 29 for adjusting the flow rate of the intake air flowing inside the low-temperature passage 23 is provided inside a part of the low-temperature passage 23 on the downstream side of the inter cooler 27 (between the inter cooler 27 and the surge tank 24).

Although the detailed illustration is omitted, each of the throttle valves 28 and 29 for the respective high-temperature and low-temperature passages 22 and 23 is a motor butterfly valve including a cylindrical valve body, a disk-like valve part rotatably arranged inside the valve body, and an electric motor serving as a drive source for rotating the valve part. Each of the flow rates of the intake air flowing inside the respective high-temperature and low-temperature passages 22 and 23 is adjusted based on a rotational angle (opening) of the valve part which is rotatably driven by the electric motor. Moreover, since the drive source of the valve part is the electric motor, different from a mechanic throttle valve (interlocked with an accelerator provided in the vehicle), the openings of the throttle valves 28 and 29 can be changed freely without any relation to an opening of the accelerator.

As described above, the butterfly valves having similar structures to each other are used as the throttle valves 28 and 29 in this embodiment. Note that, if comparing bore diameters of the respective valves, in other words, inner diameters of respective portions of the valve bodies on which the disk-like valve parts are seated, the bore diameter of the throttle valve 28 for the high-temperature passage 22 is set smaller than the bore diameter of the throttle valve 29 for the low-temperature passage 23.

The exhaust passage 30 has a plurality of independent passages 31 (only one of them is illustrated in FIG. 1) communicating with the exhaust ports 7 of the respective cylinders 2, an exhaust gas manifold section 32 where downstream end sections (downstream end sections in the flow direction of the exhaust gas) of the independent passages 31 merge together, and a single common passage 33 extending downstream from the exhaust gas manifold section 32.

An EGR device 40 includes an EGR passage 41 communicating the exhaust passage 30 with the intake passage 20, an EGR cooler 42 and a low-temperature EGR valve 43 provided within the EGR passage 41, a bypass passage 45 branching from the EGR passage 41, and a high-temperature EGR valve 46 provided within the bypass passage 45.

The EGR passage 41 circulates a part of the exhaust gas flowing inside the exhaust passage 30 back into the intake passage 20, and in this embodiment, the EGR passage 41 communicates the exhaust gas manifold section 32 of the exhaust passage 30 with the independent passages 25 of the intake passage 20. Note that, although it is not illustrated, a downstream section (an end section on the intake passage 20 side) of the EGR passage 41 is branched into a plurality of passages corresponding to the number of independent passages 25 formed for the respective cylinders 2, and each of the branched passages of the downstream section is connected with each independent passage 25.

The EGR cooler 42 is a cooled-water heat exchanger for cooling the exhaust gas flowing inside the EGR passage 41. Specifically, the EGR cooler 42 cools the exhaust gas by the heat exchange with a coolant introduced therein. The coolant used in the EGR cooler 42 may be the same kind as the coolant for cooling the engine body 1 (engine coolant). In this embodiment, a different kind of coolant from the engine coolant is used in order to obtain a higher cooling effect. Therefore, in the engine room of the vehicle of this embodiment, in addition to a main radiator for cooling the engine coolant by the heat exchange with the outdoor air, a sub-radiator for cooling the coolant for the EGR cooler 42 is provided (both radiators are not illustrated).

The low-temperature EGR valve 43 is an electric valve provided in a part of the EGR passage 41 on the downstream side of the EGR cooler 42, and an amount of the exhaust gas to be circulated back into the intake passage 20 through the EGR passage 41 is adjusted thereby.

The bypass passage 45 is provided to bypass both of the EGR cooler 42 and the EGR valve 43, and communicates a part of the EGR passage 41 on the upstream side of the EGR cooler 42 with a part of the EGR passage 41 on the downstream side of the EGR valve 43.

The high-temperature EGR valve 46 is an electric valve provided in the bypass passage 45, and the amount of the exhaust gas branched from the EGR passage 41 into the bypass passage 45 is adjusted thereby.

With such an EGR device 40 described above, when both of the low-temperature and high-temperature EGR valves 43 and 46 are closed, the flows of the exhaust gas inside either one of the EGR passage 41 and the bypass passage 45 are blocked and the amount of the exhaust gas to circulate back into the intake passage 20 becomes substantially zero. On the other hand, when the low-temperature EGR valve 43 is opened and the high-temperature EGR valve 46 is closed, the exhaust gas is circulated back into the intake passage 20 through the EGR passage 41. Therefore, all the exhaust gas circulated back into the intake passage 20 is low-temperature exhaust gas cooled by the EGR cooler 42. When the high-temperature EGR valve 46 is opened in this state, in other words, when both the low-temperature and high-temperature EGR valves 43 and 46 are opened, the exhaust gas is branched to the EGR passage 41 and the bypass passage 45 and then circulated back into the intake passage 20. Therefore, the exhaust gas circulated back into the intake passage 20 contains the low-temperature exhaust gas cooled by the EGR cooler 42 and the high-temperature exhaust gas not cooled by the EGR cooler 42.

The turbocharger 50 includes a turbine 51 provided inside the common passage 33 of the exhaust passage 30, a compressor 52 provided inside the common passage 21 of the intake passage 20, and a coupling shaft 53 coupling the turbine 51 to the compressor 52. During the engine operation, when the exhaust gas is discharged into the exhaust passage 30 from any one of the cylinders 2 of the engine body 1, by the exhaust gas passing the turbine 51 of the turbocharger 50, the turbine 51 receives the energy of the exhaust gas and rotates at a high speed. Moreover, the compressor 52 coupled to the turbine 51 via the coupling shaft 53 is rotated at the same rotational speed as the turbine 51, and thus, the intake air passing through the intake passage 20 is compressed and is pumped into the cylinder 2 of the engine body 1.

### (2) Control System

Next, a control system of the engine is described with reference to FIG. 3. Respective components of the engine of this embodiment are overall controlled by an ECU (Engine Control Unit) 60. The ECU 60 is, as well-known, comprised of a microprocessor including a CPU, a ROM, and a RAM.

The ECU 60 is inputted with various kinds of information from a plurality of sensors provided in the engine and the vehicle installed therein the engine.

Specifically, as illustrated in FIGS. 1 and 3, the engine is provided with an engine speed sensor SN1 for detecting a rotational speed of the crankshaft 15 of the engine body 1 (engine speed), a coolant temperature sensor SN2 for detecting a temperature of the coolant of the engine body 1, an intake air temperature sensor SN3 for detecting a temperature of the intake air passing through the surge tank 24, and an airflow sensor SN4 for detecting the flow rate of the intake air passing through the surge tank 24. Moreover, an outdoor air temperature sensor SN5 for detecting a temperature of the outdoor air, and an accelerator opening sensor SN6 for detecting an opening of an accelerator (accelerator opening) controlled by a driver and located outside the range of the drawings are provided in the vehicle. The ECU 60 is electrically connected with SN1 to SN6 and acquires various kinds of information described above (e.g., the engine speed, the coolant temperature, and the intake air temperature) based on signals inputted therein from the sensors. Note that, the coolant temperature sensor SN2 detects the temperature of the engine coolant serving as a heating source of the inter warmer 26 and corresponds to the “heating temperature detector” in the claims. Moreover the outdoor air temperature sensor SN5 detects the temperature of the outdoor air serving as a cooling source of the inter cooler 27 and corresponds to the “cooling temperature detector” in the claims.

Moreover, the ECU 60 executes various kinds of operations based on the input signals from the sensors SN1 to SN6 and controls the respective components of the engine. Specifically, the ECU 60 is electrically connected with the injectors 11, the ignition plugs 12, the fuel pressure control valves 14a, the changeable mechanisms 18a for the intake valves 8, the switch mechanisms 19a for the exhaust valves 9, the throttle valve 28 for the high-temperature passage 22, the throttle valve 29 for the low-temperature passage 23, the low-temperature EGR valve 43, and the high-temperature EGR valve 46. The ECU 60 outputs control signals to these components to drive them based on the operation results.

(3) Control according to Operating State

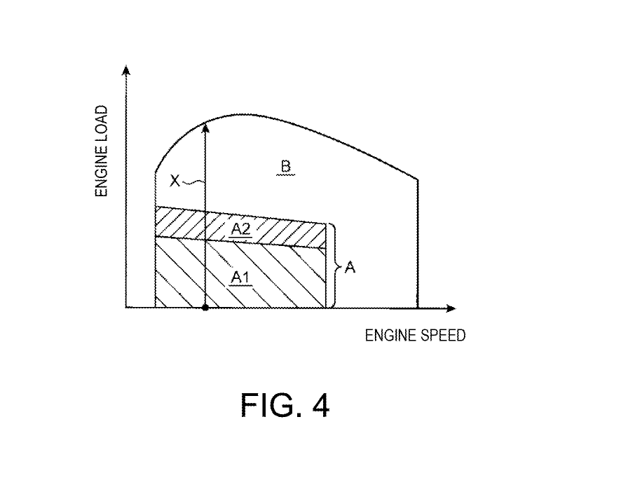

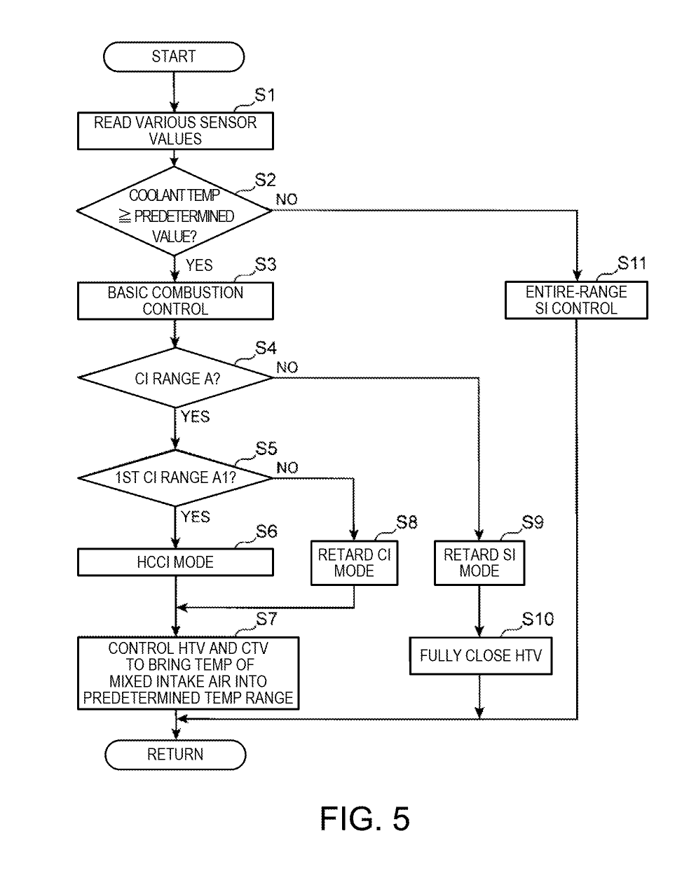

Specific contents of an engine control according to an operating state of the engine are described with reference to FIGS. 4 and 5.

FIG. 4 is a map of an operating range of the engine divided into a plurality of ranges depending on differences in the combustion mode, in which the vertical axis indicates an engine load and the horizontal axis indicates the engine speed. This map includes an SI range B set in a high engine load range within a high engine speed range, and a CI range A set in a partial engine load range other than the SI range B. Further, the CI range A is divided into a first CI range A1 and a second CI range A2 where the engine load is higher than the first range A1.

Next, the controls of the engine in the ranges A1, A2 and B of the engine described above are described with reference to the flowchart in FIG. 5. Note that, here, the description is mainly given about the substantial contents of combustion controls performed in the ranges A1, A2 and B in the map of FIG. 4, and opening controls of the throttle valves 28 and 29 for the respective high-temperature and low-temperature passages 22 and 23. The contents of controls other than these controls are described in the following section “(4) Specific Examples of Controls in Engine Load direction.”

When the processing illustrated in the flowchart of FIG. 5 is started, the ECU 60 reads the various sensor values (S1). Specifically, the ECU 60 reads detection signals from the engine speed sensor SN1, the coolant temperature sensor SN2, the intake air temperature sensor SN3, the airflow sensor SN4, the outdoor air temperature sensor SN5, and the accelerator opening sensor SN6, and acquires various kinds of information including the engine speed, the coolant temperature, the intake air temperature and the intake air flow rate inside the surge tank 24, the outdoor air temperature, and the accelerator opening, based on the detection signals.

Next, based on the information acquired from the coolant temperature sensor SN2 at S1, the ECU 60 determines whether the engine coolant temperature is above a predetermined value (e.g., 60° C.) (S2).

When it is confirmed that the coolant temperature is higher than the predetermined value (S2: YES), the ECU 60 reads data (e.g., various control target values for the respective parts of the operating range) corresponding to the map in FIG. 4 so as to perform basic combustion controls according to the map (S3).

Next, based on the information acquired at S1, the ECU 60 determines whether the engine is operated in the CI range A in the map of FIG. 4 (S4). Specifically, the ECU 60 obtains the engine load and the engine speed based on the information acquired from the engine speed sensor SN1, the airflow sensor SN4, and the accelerator opening sensor SN6, and determines whether the operating position of the engine obtained based on the engine load and the engine speed is in the CI range A in FIG. 4.

When it is confirmed that the engine is operated in the CI range A (S4: YES), the ECU 60 further determines whether the engine is operated in the first CI range A1 where the engine load is relatively low within the CI range A (S5).

When it is confirmed that the engine is operated in the first CI range A1 (S5: YES), the ECU 60 performs a combustion control in an HCCI mode (S6). The HCCI mode indicates a combustion control in which the mixture gas (pre-mixture gas) obtained by mixing the fuel and air in advance is compressed to self-ignite.

Specifically, in the HCCI mode, in a sufficiently earlier stage than a compression top dead center (CTDC) (e.g., during the intake stroke), the fuel is injected from the injector 11 into the combustion chamber 10. The injected fuel is sufficiently mixed with air before the piston 5 reaches the CTDC, and thus, comparatively homogeneous mixture gas is formed. The mixture gas self-ignites to combust near the CTDC where the temperature and the pressure inside the combustion chamber 10 are sufficiently increased.

Meanwhile, in the first CI range A1 for which the HCCI mode is selected, since the engine load is comparatively low, it is normally difficult to increase the temperature inside the combustion chamber 10 up to the temperature at which the mixture gas can self-ignite. Therefore, due to the mode being the HCCI mode, the ECU 60 controls the throttle valves 28 and 29 such that the intake air heated by the inter warmer 26 and the intake air cooled by the inter cooler 27 are mixed at a suitable ratio (S7), and increases the temperature of the mixed intake air, in other words, the intake air temperature inside the surge tank 24, up to a predetermined temperature range (e.g., 50±5° C.). Thus, the warm intake air of which temperature is increased to the predetermined temperature range is introduced into the cylinders 2 of the engine body 1 through the independent passages 25, and therefore, the self-ignition of the mixture gas inside each cylinder 2 is stimulated and stable CI combustion is achieved. Note that, in the flowchart of FIG. 5, the throttle valve 28 for the high-temperature passage 22 is described as “HTV,” and the throttle valve 29 for the low-temperature passage 23 is described as “CTV.”

Specifically, at S7, based on the outdoor air temperature and the engine coolant temperature acquired at S1, the openings of the throttle valves 28 and 29 for the respective high-temperature and low-temperature passages 22 and 23 are controlled to adjust the mixture ratio between the high-temperature intake air after passing through the inter warmer 26 (the intake air at substantially the same temperature as that of the engine coolant) and the low-temperature intake air after passing through the inter cooler 27 (the intake air at substantially the same temperature as that of the outdoor air). Thus, the temperature of the mixed intake air is brought into the predetermined temperature range.

For example, as the engine coolant temperature becomes higher, the intake air heated by the inter warmer 26 using the engine coolant becomes higher. Therefore, if the intake air temperature inside the low-temperature passage 23 is fixed, the intake air flow rate inside the high-temperature passage 22 required for bringing the temperature of the mixed intake air into the predetermined temperature range becomes lower as the engine coolant temperature becomes higher. On the other hand, the temperature of the intake air cooled by the inter cooler 27 using the traveling air becomes higher as the outdoor air temperature becomes higher. Thus, if the intake air temperature inside the high-temperature passage 22 is fixed, the intake air flow rate inside the low-temperature passage 23 required for bringing the temperature of the mixed intake air into the predetermined temperature range becomes higher as the outdoor air temperature becomes higher.

Considering such situations, the ECU 60 stores map data used to determine the openings of the throttle valves 28 and 29 for the respective high-temperature and low-temperature passages 22 and 23, based on the engine coolant temperature and the outdoor air temperature. At S7, the ECU 60 determines the openings (target openings) of the throttle valves 28 and 29 to be set, based on the engine coolant temperature acquired from the coolant temperature sensor SN2, the outdoor air temperature acquired from the outdoor air temperature sensor SN5, and the map data described above, and the ECU 60 controls the throttle valves 28 and 29 to match with the respective target openings. Further, the ECU 60 corrects the openings of the throttle valves 28 and 29 while feeding back the actual intake air temperature detected within the surge tank 24 (the detection value from the intake air temperature sensor SN3). Thus, the temperature of the mixed intake air in the surge tank 24 is brought into the predetermined temperature range with high accuracy.

Next, a control operation in a case where the engine is operated in the second CI range A2 (S5: NO) is described. In this case, the ECU 60 performs a combustion control in a retard CI mode (S8). The retard CI mode indicates a combustion control in which at least a part of the fuel to be injected is injected near the CTDC to cause a self-ignition of the fuel in a short period of time thereafter.

Specifically, in the retard CI mode, the fuel pressure control valve 14a of the supply pump 14 is driven to increase the fuel injection pressure (fuel pressure) from the injector 11, and then the fuel is injected from the injector 11 at a slightly retarded timing near the CTDC. The fuel injected at a high-pressure at such a timing (the timing at which the temperature of the combustion chamber 10 is sufficiently increased) is immediately vaporized inside the combustion chamber 10, then self-ignites at a suitable timing after the CTDC and is combusted. The retard CI mode where the fuel injection timing is retarded is selected for the second CI range A2 where the engine load is higher than the first CI range A1 as described above because, if the fuel is injected at substantially the same timing as that in the first CI range A1, the timing at which the mixture gas self-ignites becomes excessively early and, thus, abnormal combustion or excessive combustion sound may be caused. Note that, in the retard CI mode, it is not necessary to inject all the fuel to be injected near the CTDC, and a part of the fuel may be injected on the intake stroke, etc.

Also in the retard CI mode, similarly to the HCCI mode described above, the ECU 60 controls the openings of the throttle valves 28 and 29 for the respective high-temperature and low-temperature passages 22 and 23 (S7). Specifically, the mixture ratio between the high-temperature intake air after passing through the inter warmer 26 and the low-temperature intake air after passing through the inter cooler 27 is adjusted by the opening control of the throttle valves 28 and 29, and thus, the temperature of the mixed intake air, in other words, the temperature of the intake air inside the surge tank 24 is brought into a predetermined temperature range (e.g., 50±5° C.).

Next, a control operation in a case where the engine is operated in the SI range B (S4: NO) is described. In this case, the ECU 60 performs a combustion control in a retard SI mode (S9). The retard SI mode indicates a control in which at least a part of the fuel to be injected is injected near the CTDC and the fuel is forcibly combusted by a spark-ignition performed soon thereafter.

Specifically, in the retard SI mode, the fuel pressure control valve 14a of the supply pump 14 is driven to increase the fuel injection pressure (fuel pressure) from the injector 11, and then the fuel is injected from the injector 11 at a retarded timing near the CTDC. Further, the ignition plug 12 is driven at a timing soon thereafter and the ignition energy produced by the spark-ignition is supplied. The fuel from the injector 11 is injected at a high-pressure at the retarded timing near the CTDC (the timing at which the temperature of the combustion chamber 10 is sufficiently increased) and is immediately vaporized. The vaporized fuel is then spark-ignited and, thus, the combustion of the vaporized fuel is started at a suitable timing after the CTDC. Although the combustion mode here, differently from the HCCI mode and the retard CI mode described above, is combustion in which flame spreads gradually due to flame propagation (SI combustion), since the combustion is generated with a high turbulence kinetic energy produced soon after the fuel is injected at a high-pressure, the combustion period is sufficiently short and, thus, comparatively rapid SI combustion with a high thermal efficiency can be achieved. Moreover, since the fuel injection timing is sufficiently retarded, abnormal combustion (e.g., knocking and pre-ignition) which easily occurs with a high engine load can be avoided. Note that, in the retard SI mode, it is not necessary to inject all the fuel to be injected near the CTDC, and a part of the fuel may be injected on the intake stroke, etc.

Since the combustion mode in the retard SI mode is the SI combustion in which the mixture gas is forcibly combusted by the spark-ignition as described above, it is no longer necessary to increase the temperature of the combustion chamber 10 intentionally. Thus, due to the performance in the retard SI mode, the ECU 60 fully closes the throttle valve 28 for the high-temperature passage 22 (S10). Thus, the high-temperature passage 22 is blocked and, therefore, the high-temperature intake air heated by the inter warmer 26 does not flow into the surge tank 24, and as a result, all the intake air introduced into the engine body 1 becomes the low-temperature intake air (having substantially the same temperature as the outdoor air) cooled by the inter cooler 27.

Next, a control operation in a case where the engine coolant temperature is lower than the predetermined value (e.g., 60° C.) (S2: NO) is described. In this case, the ECU 60 performs an entire-range SI control in which the SI combustion is performed in the entire operating range of the engine (S11), not in accordance with the map in FIG. 4. Specifically, when the engine coolant temperature is low, the intake air cannot be sufficiently heated by using the inter warmer 26 and, moreover, the temperature of a wall face of the combustion chamber 10 is also low, and thus, it is difficult for the mixture gas to self-ignite. Therefore, in such a case, the forcible combustion by the spark-ignition, in other words, the SI combustion is performed in the entire operating range of the engine.

### (4) Specific Example of Controls in Engine Load Direction

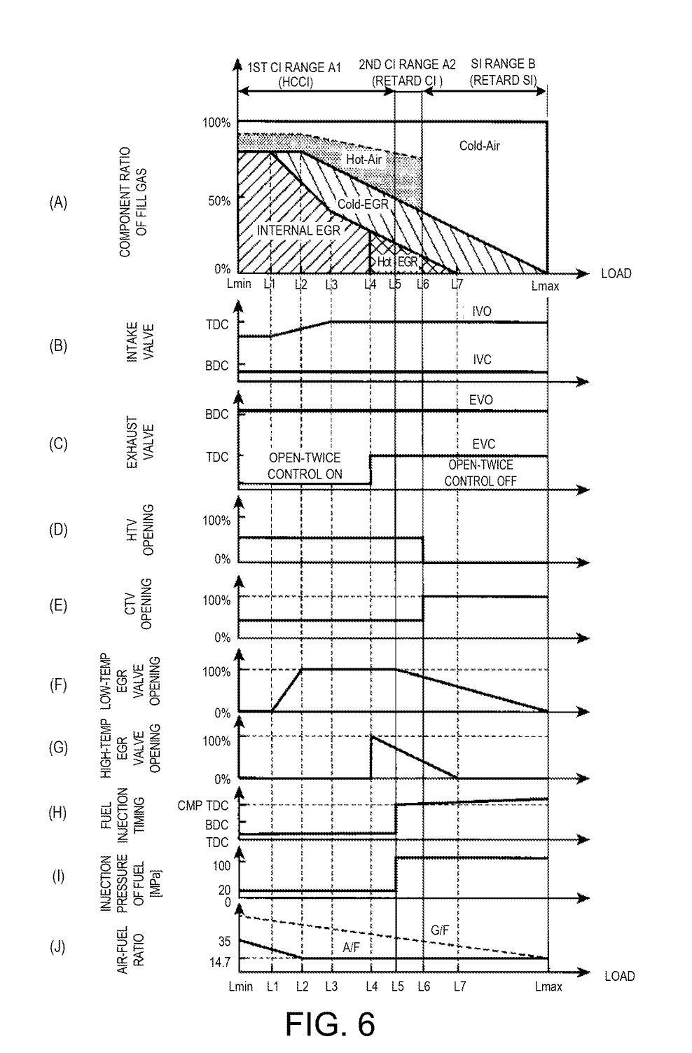

Next, changes of the various state amounts of the engine when the basic combustion controls based on the map in FIG. 4 (S3 to S10 in FIG. 5) are performed are described in detail based on FIG. 6. Here, transitions of the various state amounts when the operating position of the engine is shifted as the arrow X in the map of FIG. 4, in other words, when the operating position is shifted in the engine load direction such as to shift from the first CI range A1, to the second CI range A2, and then to the SI range B in this order are shown. In FIG. 6, Lmin indicates the lowest engine load and Lmax indicates the highest engine load, and each of the loads L1, L2, L3, L5, L6 and L7 is a switching point of at least one of the controls performed in this embodiment. Note that, the engine load range corresponding to the first CI range A1 (HCCI mode) is from Lmin to L5, the engine load range corresponding to the second CI range A2 (retard CI mode) is from L5 to L6, and the engine load range corresponding to the SI range B (retard SI mode) is from L6 to Lmax.

The chart (A) in FIG. 6 illustrates a breakdown of fill gas introduced into the combustion chamber 10 of each cylinder 2, in other words, a component ratio of the fill gas when a maximum fill amount which can be filled in the combustion chamber 10 at each load is 100%. In FIG. 6, “internal EGR” means the high-temperature exhaust gas remained in the combustion chamber 10 by an operation where the open-twice control of the exhaust valve 9 (opening the exhaust valve 9 not only on the exhaust stroke but also on the intake stroke by activating the switch mechanism 19a) is performed to reverse the exhaust gas from the exhaust port 7. Moreover, “Hot-EGR” means the high-temperature exhaust gas circulated back into the combustion chamber 10 through the bypass passage 45 of the EGR device 40, and “Cold-EGR” means the low-temperature exhaust gas circulated back into the combustion chamber 10 through the EGR passage 41 of the EGR device 40 (i.e., after being cooled by the EGR cooler 42). Further, “Hot-Air” means the high-temperature intake air (fresh air) introduced into the combustion chamber 10 through the high-temperature passage 22 of the intake passage 20, and “Cold-Air” means the low-temperature intake air (fresh air) introduced into the combustion chamber 10 through the low-temperature passage 23 of the intake passage 20.

The charts in FIG. 6 other than the chart (A) illustrate the following state amounts. Specifically, the chart (B) shows an open timing (IVO) and a close timing (IVC) of the intake valve 8, the chart (C) shows an open timing (EVO) and a close timing (EVC) of the exhaust valve 9, the chart (D) shows the opening of the throttle valve 28 for the high-temperature passage 22 (HTV), the chart (E) shows the opening of the throttle valve 29 for the low-temperature passage 23 (CTV), the chart (F) shows an opening of the low-temperature EGR valve 34, the chart (G) shows an opening of the high-temperature EGR valve 46, the chart (H) shows an injection timing of the fuel from the injector 11, the chart (I) shows the injection pressure of the fuel from the injector 11 (fuel pressure), and the chart (J) shows an air-fuel ratio within the combustion chamber 10. Note that, in the chart (J) about the air-fuel ratio, A/F is a value obtained by dividing the mass of the intake air (fresh air) introduced into the combustion chamber 10 by the mass of the fuel, and G/F is a value obtained by dividing the mass of all the gas introduced into the combustion chamber 10 by the mass of the fuel (gas air-fuel ratio).

As illustrated in the chart (B) of FIG. 6, when the engine load is between Lmin and L1, a lift of the intake valve 8 is set to a predetermined small lift by the changeable mechanism 18a, and accordingly, an open period of the intake valve 8 (a period between IVO and IVC) is set short. On the other hand, when the engine load is between L1 and L3, the lift (open period) of the intake valve 8 is gradually increased to be fixed at a maximum value thereof in an engine load range higher than L3.

As illustrated in the chart (C) of FIG. 6, when the engine load is between Lmin and L4, the exhaust valve 9 is opened not only on the exhaust stroke but also on the intake stroke by activating the switch mechanism 19a (open-twice control). On the other hand, when the engine load is between L4 and Lmax, the switch mechanism 19a is deactivated to stop the open-twice control of the exhaust valve 9.

As illustrated in the chart (D) of FIG. 6, when the engine load is between Lmin and L6, the opening of the throttle valve 28 for the high-temperature passage 22 is set to a predetermined intermediate opening (the opening determined at S7 in FIG. 5). As the engine load exceeds L6, the opening of the throttle valve 28 is reduced to be fully closed (0%) and kept in this state until the engine load becomes Lmax.

As illustrated in the chart (E) of FIG. 6, when the engine load is between Lmin and L6, the opening of the throttle valve 29 for the low-temperature passage 23 is set to a predetermined intermediate opening (the opening determined at S7 in FIG. 5). As the engine load exceeds L6, the opening of the throttle valve 29 is increased to be fully opened (100%) and kept in this state until the engine load becomes Lmax.

As illustrated in the chart (F) of FIG. 6, the opening of the low-temperature EGR valve 43 is set to be fully closed (0%) when the engine load is between Lmin and L1. As the engine load exceeds L1, the opening of the low-temperature EGR valve 43 is gradually increased to be fully opened (100%) at L2. The opening of the low-temperature EGR valve 43 is kept fully opened (100%) when the engine load is between L2 and L5; however, as the engine load exceeds L5, the opening is again reduced to be fully closed (0%) at Lmax.

As illustrated in the chart (G) of FIG. 6, the opening of the high-temperature EGR valve 46 is set to be fully closed (0%) when the engine load is between Lmin and L4. As the engine load exceeds L4, the opening of the high-temperature EGR valve 46 is rapidly increased to be fully opened (100%); however, the opening is gradually reduced thereafter to be fully closed (0%) at L7. Further, when the engine load is between L7 and Lmax, the opening is fully closed (0%).

As illustrated in the chart (H) of FIG. 6, when the engine load is between Lmin and L5, the injection timing of the fuel from the injector 11 is set to a predetermined timing within the intake stroke (between BDC and TDC). As the engine load exceeds L5, the injection timing is retarded to near the CTDC and is kept to substantially the same timing until Lmax. Note that, the injection timing in an engine load range higher than L5 is, more specifically, more retarded little by little as the engine load approaches Lmax.

As illustrated in the chart (I) of FIG. 6, when the engine load is between Lmin and L5, the fuel injection pressure (fuel pressure) is set to about 20 MPa. As the engine load exceeds L5, the fuel pressure is increased to 100 MPa or higher and is kept to substantially the same value until Lmax.

Based on the changes of the various state amounts according to the engine load as described above, the breakdown of the gas within the combustion chamber 10 changes as follows.

When the engine load is between Lmin and L1, the number of kinds of gas filling the combustion chamber 10 is three, including the high-temperature intake air introduced from the high-temperature passage 22 (Hot-Air), the low-temperature intake air introduced from the low-temperature passage 23 (Cold-Air), and the high-temperature exhaust gas introduced by the open-twice control of the exhaust valve 9 (internal EGR) (the chart (A) in FIG. 6). The amount of the exhaust gas generated by the internal EGR is particularly large among the three kinds, and the combustion chamber 10 is mainly filled with the high-temperature exhaust gas.

When the engine load is between L1 and L4, the number of kinds of gas filling the combustion chamber 10 is four, including the high-temperature intake air introduced from the high-temperature passage 22 (Hot-Air), the low-temperature intake air introduced from the low-temperature passage 23 (Cold-Air), the low-temperature exhaust gas introduced after being cooled by the EGR cooler 42 (Cold-EGR), and the high-temperature exhaust gas introduced by the open-twice control of the exhaust valve 9 (internal EGR) (the chart (A) in FIG. 6). The amount of the intake air, in other words, the total amount of fresh air in which the high-temperature intake air is mixed with the low-temperature intake air is gradually increased as the engine load is increased. On the other hand, the amount of the exhaust gas generated by the internal EGR is gradually reduced as the engine load is increased.

When the engine load is between L4 and L6, the number of kinds of gas filling the combustion chamber 10 is four, including the high-temperature intake air introduced from the high-temperature passage 22 (Hot-Air), the low-temperature intake air introduced from the low-temperature passage 23 (Cold-Air), the low-temperature exhaust gas introduced after being cooled by the EGR cooler 42 (Cold-EGR), and the high-temperature exhaust gas introduced without being cooled by the EGR cooler 42 (Hot-EGR). The amount of the high-temperature exhaust gas (Hot-EGR) is gradually reduced as the engine load is increased from L4 to L6, and instead, the amount of the intake air is increased.

When the engine load is between L6 and Lmax, the number of kinds of gas filling the combustion chamber 10 is two, including the low-temperature intake air introduced from the low-temperature passage 23 (Cold-Air), and the low-temperature exhaust gas introduced after being cooled by the EGR cooler 42 (Cold-EGR). Note that, near the engine load L6 on the lower engine load side, a small amount of the high-temperature exhaust gas not being cooled by the EGR cooler 42 (Hot-EGR) is introduced into the combustion chamber 10. The amount of the low-temperature exhaust gas introduced after being cooled by the EGR cooler 42 (Cold-EGR) is gradually reduced as the engine load is increased from L6 to Lmax, and instead, the amount of the intake air (here, the intake air is all low-temperature intake air) is gradually increased.

Then, under the environments of the combustion chamber 10 created for the respective engine load ranges described above, with reference to the flowchart in FIG. 5, in this embodiment, the combustion control in the HCCI mode is performed in the first CI range A1 (between Lmin and L5), the combustion control in the retard CI mode is performed in the second CI range A2 (between L5 and L6), and the combustion control in the retard SI mode is performed in the SI range B (between L6 and Lmax).

[Specifically, in the first CI range A1, a part of the intake air is heated by passing through the high-temperature passage 22 and then introduced into the combustion chamber 10 by opening both the throttle valves 28 and 29 for the respective high-temperature and low-temperature passages 22 and 23 (the charts (D) and (E) in FIG. 6). Moreover, the combustion chamber 10 is introduced with either one of the high-temperature exhaust gases reversed from the exhaust port 7 by the open-twice control of the exhaust valve 9 (the chart (C) in FIG. 6) and the high-temperature exhaust gas circulated without passing through the EGR cooler 42 by the control of the high-temperature EGR valve 43 to open (the chart (G) in FIG. 6). Thus, the temperature inside the combustion chamber 10 can be increased. The fuel is injected from the injector 11 during the intake stroke (the chart (H) in FIG. 6), and the fuel pressure in this injection is set to about 20 MPa (the chart (I) in FIG. 6). The air-fuel ratio A/F based on the injected fuel is set to a lean value which is higher than a theoretical air-fuel ratio (=14.7:1) in the engine load range between Lmin and L2, and the air-fuel ratio A/F is set to the theoretical air-fuel ratio in the engine load range from L2 (the chart (J) in FIG. 6). As a result of these controls, in the first CI range A1, the sufficiently mixed pre-mixture gas self-ignites near the CTDC and combusts (HCCI mode).

In the second CI range A2, similarly to the high engine load range (between L4 and L5) within the first CI range A1, both the throttle valves 28 and 29 for the respective high-temperature and low-temperature passages 22 and 23 are opened (the charts (D) and (E) in FIG. 6) and the high-temperature EGR valve 43 is opened (the chart (G) in FIG. 6) to increase the temperature inside the combustion chamber 10. Moreover, the injection timing of the fuel from the injector 11 is retarded to near the CTDC (the chart (H) in FIG. 6), and the fuel pressure in this injection is increased to 100 MPa or higher (the chart (I) in FIG. 6). The air-fuel ratio A/F based on the injected fuel is set to the theoretical air-fuel ratio (=14.7:1) (the chart (J) in FIG. 6). As a result of these controls, in the second CI range A2, the fuel, soon after being injected, self-ignites at the timing after the CTDC and combusts (retard CI mode).

In the SI range B, the opening of the throttle valve 28 for the high-temperature passage 22 is set to be fully closed (0%), and only the throttle valve 29 for the low-temperature passage 23 is opened (the charts (D) and (E) in FIG. 6). Thus, the high-temperature intake air heated by the inter warmer 26 is no longer introduced into the combustion chamber 10 and the temperature inside the combustion chamber 10 can be reduced. Moreover, the timing of the injection by the injector 11 is after the CTDC (the chart (H) in FIG. 6) and the fuel pressure is set to 100 MPa or higher (the chart (I) in FIG. 6). Further, although it is not illustrated in FIG. 6, the spark-ignition by the ignition plug 12 is performed at a timing soon after the fuel is injected. The air-fuel ratio A/F based on the injected fuel is set to the theoretical air-fuel ratio (=14.7:1) (the chart (J) in FIG. 6). As a result of these controls, in the SI range B, the fuel, soon after being injected, is focibly combusted by the spark-ignition at the timing after the CTDC (retard SI mode).

### (5) Operation, etc.

As described above, with the compression self-ignition engine of this embodiment, the fuel contains gasoline, and in a part of the operating range except for the high engine load range and the high engine speed range, in other words, in the CI range A (the first and second CI ranges A1 and A2), the CI combustion in which the fuel combusts by the self-ignition is performed. The intake passage 20 of the engine of this embodiment has: the high-temperature passage 22 provided with the inter warmer 26 (heater) for heating the intake air; the low-temperature passage 23 arranged in parallel with the high-temperature passage 22 and provided with the inter cooler 27 (cooler) for cooing the intake air; the surge tank 24 (manifold section) where the high-temperature passage 22 and the low-temperature passage 23 merge together; and the independent passages 25 (downstream passages) connecting the surge tank 24 with the engine body 1. The high-temperature passage 22 and the low-temperature passage 23 are provided with the throttle valves 28 and 29 for adjusting the flow rate of the intake air, respectively. Each of the openings of the throttle valves 28 and 29 is controlled to bring the intake air temperature inside the surge tank 24 into the predetermined temperature range (e.g., 50±5° C.) in the CI range A. Such a configuration has an advantage that the intake air temperature can be controlled highly accurately in the part of the operating range where the CI combustion is performed (i.e., CI range A).

Specifically, in this embodiment, the inter warmer 26 for heating the intake air and the inter cooler 27 for cooling the intake air are provided in the separate passages (the high-temperature passage 22 and the low-temperature passage 23) respectively, and the throttle valves 28 and 29 for adjusting the flow rates are provided inside the respective passages 22 and 23. Therefore, even if the temperature conditions of the inter warmer 26 and the inter cooler 27 vary according to the situation (e.g., the warming-up stage of the engine and the outdoor air temperature), by flexibly adjusting the mixing ratio of the intake air from the high-temperature passage 22 and the low-temperature passage 23, the temperature of the mixed intake air, in other words, the temperature of the intake air introduced into the engine body 1 after merging together in the surge tank 24, can be brought into the predetermined temperature range with high accuracy. Moreover, since the flow rates inside the high-temperature passage 22 and the low-temperature passage 23 can be controlled by the respective throttle valves 28 and 29 individually, the temperature of the mixed intake air can be adjusted in excellent responsiveness. Therefore, in the part of the operating range where the CI combustion is performed (CI range A), the environment where the fuel self-ignites at a suitable timing can surely be created and the stability of the CI combustion can be improved.

More specifically, the engine of this embodiment includes the coolant temperature sensor SN2 (heating temperature detector) for detecting the temperature of the engine coolant serving as the heating source of the inter warmer 26, and the outdoor air temperature sensor SN5 (cooling temperature detector) for detecting the temperature of the outdoor air serving as the cooling source of the inter cooler 27. The openings of the throttle valves 28 and 29 for the respective high-temperature and low-temperature passages 22 and 23 are controlled based on the detection values of the sensors SN2 and SN5. According to such a configuration, the flow rates inside the high-temperature passage 22 and the low-temperature passage 23 can be suitably controlled by the respective throttle valves 28 and 29 based on the temperature of the heating source which controls the temperature of the intake air after passing through the inter warmer 26 and the temperature of the cooling source which controls the temperature of the intake air after passing through the inter cooler 27. Thus, the accuracy of the temperature control described above can be improved.

Moreover, in this embodiment, a difference between the distribution resistance of the intake air flowing inside the inter warmer 26 and the distribution resistance of the intake air flowing inside the inter cooler 27 is set within the range of 20% under the same flow rate. According to such a configuration, since a difference in response delay caused between the flow rates inside the high-temperature and low-temperature passages 22 and 23 when the openings of the throttle valves 28 and 29 are changed is not significant, the temperature of the intake air introduced into the engine body 1 can easily and surely be brought into the predetermined temperature range.

For example, in a case where the distribution resistance of the intake air flowing inside the inter warmer 26 is significantly different from the distribution resistance of the intake air flowing inside the inter cooler 27, a difference between the response delay of the flow rate change by the opening control of the throttle valve 28 for the high-temperature passage 22 and the response delay of the flow rate change by the opening control of the throttle valve 29 for the low-temperature passage 23 is large enough to put into consideration. Therefore, the openings of the throttle valves 28 and 29 need to be controlled by taking the difference in response delay into consideration, resulting in complicating the control. Whereas, as this embodiment, in the case where the difference in distribution resistance is set small, it is only necessary to control both the throttle valves 28 and 29 basically at the same timing. Therefore, the control can be simple and the accuracy of the temperature control can be improved.

Moreover, in this embodiment, the throttle valves 28 and 29 for the respective high-temperature and low-temperature passages 22 and 23 are both butterfly throttle valves, and the bore diameter of the throttle valve 28 for the high-temperature passage 22 is set smaller than that of the throttle valve 29 for the low-temperature passage 23. When the bore diameter of the throttle valve 28 for the high-temperature passage 22 is set small as described above, since the amount of leakage caused when the throttle valve 28 is fully closed can be reduced, abnormal combustion (e.g., knocking) can effectively be prevented in the part of the operating range where the temperature increase of the intake air degrades the combustion stability, for example, near the maximum engine load Lmax.

Although butterfly throttle valves are generally excellent in controllability for flow rates, they have a property that even after the openings thereof are reduced to the state of being fully closed, some extent of leakage occurs. Therefore, if the bore diameter of the throttle valve 28 for the high-temperature passage 22 is large, a comparatively large amount of high-temperature intake air leaks downstream of the throttle valve 28 in the SI range B where the throttle valve 28 is set to be fully closed, resulting in unnecessarily increasing the temperature of the combustion chamber 10. Whereas, in this embodiment, since the bore diameter of the throttle valve 28 for the high-temperature passage 22 is smaller than the bore diameter of the throttle valve 29 for the low-temperature passage 23, air proof performance is improved and the amount of leakage can be reduced when the throttle valve 28 is fully closed. Thus, it can be avoided that a large amount of high-temperature intake air leaks downstream of the throttle valve 28 which is fully closed, particularly in a high engine load range within the SI range B (near the maximum engine load Lmax); therefore, abnormal combustion (e.g., knocking) can effectively be prevented.

Moreover, in this embodiment, the throttle valve 28 for the high-temperature passage 22 is provided downstream of the inter warmer 26 within the high-temperature passage 22. According to such a configuration, compared to the case where the throttle valve 28 for the high-temperature passage 22 is provided upstream of the inter warmer 26, a volume of a part of the high-temperature passage on the downstream side of the throttle valve, where the high-temperature intake air may exist can be reduced. Therefore, when the throttle valve 28 is fully closed, the high-temperature intake air is used up in the respective cylinders 2 of the engine body 1 within an extremely short period of time. Thus, it can be avoided that the high-temperature intake air is introduced into the engine body 1 at an unsuitable timing; therefore, abnormal combustion which may occur in a transitive situation can effectively be prevented.

Note that, in this embodiment, the openings of the throttle valves 28 and 29 for the high-temperature passage 22 and the low-temperature passage 23 are controlled based on the detection value of the coolant temperature sensor SN2 for detecting the temperature of the engine coolant serving as the heating source of the inter warmer 26 and the detection value of the outdoor air temperature sensor SN5 for detecting the temperature of the outdoor air serving as the cooling source of the inter cooler 27; however, other kinds of detailed methods may be considered as long as the throttle valves 28 and 29 are controlled based on the respective temperature conditions of the inter warmer 26 and the inter cooler 27 (in other words, based on the state amount representing the temperatures of the intake air after passing through the inter warmer 26 and the state amount representing the temperatures of the intake air after passing through the inter cooler 27). For example, temperature sensors may be respectively provided within a part of the high-temperature passage 22 on the downstream side of the inter warmer 26 and a part of the low-temperature passage 23 on the downstream side of the inter cooler 27, and the openings of the throttle valves 28 and 29 may be controlled based on the temperature of the heated intake air detected by one of the temperature sensors and the temperature of the cooled intake air detected by the other temperature sensor, respectively.

Moreover, in this embodiment, the engine coolant is used as the heating source of the inter warmer 26 and the outdoor air (traveling air) is used as the cooling source of the inter cooler 27; however, various kinds of alternatives can be considered as long as the heating source and the cooling source are able to heat/cool the intake air. For example, an electric heater may be used as the inter warmer 26 and a cooled-water heat exchanger may be used as the inter cooler 27.

Moreover, in this embodiment, during the engine operation in the CI range A where the CI combustion is performed (the first CI range A1 and the second CI range A2), the intake air from the high-temperature passage 22 and the intake air from the low-temperature passage 23 are mixed (in other words, both of the throttle valves 28 and 29 are opened) to increase the temperature of the mixed intake air to the fixed temperature range (e.g., 50±5° C.); however, the target temperature range (predetermined temperature range) may be different according to the engine load and the engine speed.

Moreover, in this embodiment, during the engine operation in the SI range B where the SI combustion is performed, the throttle valve 28 for the high-temperature passage 22 is fixed fully closed to prohibit the heated high-temperature intake air from being introduced into the engine body 1; however, for example, in a low engine load range within the SI range B, since a comparatively large amount of the exhaust gas is introduced into the combustion chamber 10 through the EGR device 40 (see the chart (A) in FIG. 6), the combustion may be unstabilized. Thus, in the SI range B, it may be such that the throttle valve 28 for the high-temperature passage 22 is only opened in a part of the low engine load range within the SI range B (e.g., between L6 and L7).

Moreover, in this embodiment, one ignition plug 12 is provided to each cylinder 2 of the engine body 1; however, a plurality of (e.g., two) ignition plugs may be provided to each cylinder 2. Thus, the combustion speed in the SI combustion performed in the SI range B is accelerated, and therefore, more improvement of the thermal efficiency can be expected.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

### DESCRIPTION OF REFERENCE NUMERALS

1 Engine Body
20 Intake Passage
22 High-temperature Passage
23 Low-temperature Passage
24 Surge Tank (Manifold Section)
25 Independent Passages (Downstream Passages)
26 Inter Warmer (Heater)
27 Inter Cooler (Cooler)
28 Throttle Valve (for High-temperature Passage)
29 Throttle Valve (for Low-temperature Passage)
SN2 Coolant Temperature Sensor (Heating Temperature Detector)
SN5 Outdoor Air Temperature Sensor (Cooling Temperature Detector)

What is claimed is:

1. A compression self-ignition engine including an engine body driven by fuel containing gasoline, and an intake passage through which intake air introduced into the engine body flows, CI combustion in which the fuel combusts by self-ignition, being performable in at least a part of an engine operating range, the intake passage comprising:
a high-temperature passage provided with a heater for heating intake air;
a low-temperature passage provided with a cooler for cooling the intake air;
a manifold section where the high-temperature passage and the low-temperature passage merge together; and
a downstream passage connecting the manifold section with the engine body,
wherein a throttle valve for adjusting a flow rate of the intake air is provided in each of the high-temperature passage and the low-temperature passage, and
wherein at least in an engine operating range where the CI combustion is performed, openings of the throttle valves for the high-temperature and low-temperature passages are controlled to bring a temperature of the intake air within the manifold section into a predetermined temperature range, based on temperature conditions of the heater and the cooler, respectively.

2. The engine of claim 1, further comprising:
a heating temperature detector for detecting a temperature of a heating source of the heater; and
a cooling temperature detector for detecting a temperature of a cooling source of the cooler,
wherein the openings of the throttle valves for the high-temperature and low-temperature passages are controlled based on detection values from the heating temperature detector and the cooling temperature detector, respectively.

3. The engine of claim 1, wherein a difference between distribution resistance of the intake air flowing inside the heater and distribution resistance of the intake air flowing inside the cooler is within a range of 20% under the same flow rate.

4. The engine of claim 2, wherein a difference between distribution resistance of the intake air flowing inside the heater and distribution resistance of the intake air flowing inside the cooler is within a range of 20% under the same flow rate.

5. The engine of claim 1, wherein the throttle valves for the respective high-temperature and low-temperature passages are both butterfly throttle valves, and
wherein a bore diameter of the throttle valve for the high-temperature passage is set smaller than a bore diameter of the throttle valve for the low-temperature passage.

6. The engine of claim 2, wherein the throttle valves for the respective high-temperature and low-temperature passages are both butterfly throttle valves, and
wherein a bore diameter of the throttle valve for the high-temperature passage is set smaller than a bore diameter of the throttle valve for the low-temperature passage.

7. The engine of claim 3, wherein the throttle valves for the respective high-temperature and low-temperature passages are both butterfly throttle valves, and
wherein a bore diameter of the throttle valve for the high-temperature passage is set smaller than a bore diameter of the throttle valve for the low-temperature passage.

8. The engine of claim 4, wherein the throttle valves for the respective high-temperature and low-temperature passages are both butterfly throttle valves, and
wherein a bore diameter of the throttle valve for the high-temperature passage is set smaller than a bore diameter of the throttle valve for the low-temperature passage.

9. The engine of claim 5, wherein the throttle valve for the high-temperature passage is provided downstream of the heater within the high-temperature passage.

10. The engine of claim 6, wherein the throttle valve for the high-temperature passage is provided downstream of the heater within the high-temperature passage.

11. The engine of claim 7, wherein the throttle valve for the high-temperature passage is provided downstream of the heater within the high-temperature passage.

12. The engine of claim 8, wherein the throttle valve for the high-temperature passage is provided downstream of the heater within the high-temperature passage.
